(19) United States
(12) Patent Application Publication
(10) Pub. No.: US 2009/0101167 A1
(43) Pub. Date: Apr. 23, 2009

(54) Use of Surface-Active Non-Enzymatic Proteins for Washing Textiles

(75) Inventors: Dieter Boeckh, Limburgerhof (DE); Volker Schwendemann, Neustadt (DE); Ulf Baus, Dossenheim (DE); Thorsten Montag, Dudenhofen (DE); Marvin Karos, Schwetzingen (DE); Thomas Subkowski, Ladenburg (DE); Claus Bollschweiler, Heidelberg (DE); Hans-Georg Lemaire, Limburgerhof (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 11/989,746

(22) PCT Filed: Jul. 27, 2006
(86) PCT No.: PCT/EP2006/064720

§ 371 Date: Jan. 30, 2008

(30) Foreign Application Priority Data
Aug. 1, 2005 (DE) 10 2005 036 586.8

(51) Int. Cl. C11D 3/26; B08B 7/00

(52) U.S. Cl. 134/6; 510/356

(57) ABSTRACT

The use of interface-active non-enzymatic proteins for textile washing. Washing compositions for textile washing which comprise interface-active non-enzymatic proteins, and processes for washing using such proteins.

The present invention relates to the use of interface-active non-enzymatic proteins for textile washing. It further relates to washing compositions for textile washings which comprise interface-active non-enzymatic proteins and to a process for washing using such proteins.

The removal of soil, especially of hydrophobic stains, in textile washing succeeds at present to a satisfactory degree only at relatively high temperatures. At moderate temperatures and especially at room temperature, there is still considerable demand for an improvement of the washing performance. According to the prior art, the removal of hydrophobic stains is achieved in particular with surfactants and lipolytic enzymes.

The use of enzymatic proteins as an additive to washing compositions is known in principle. Especially proteases are used in washing compositions, but the use of amylases, cellulases or lipases is also known. Further details are given, for example, in “Waschmittel-Enzyme” [Washing composition enzymes] in Römpp Chemie-Lexikon, Online edition, Version 2.6, Georg-Thieme-Verlag, Stuttgart, New York, February 2005.

It is also known that proteins can be used in order to fix washing assistants, for example fixatives, UV protectants, perfuming substances or soil-detaching assistants, to the fiber. For this purpose, WO 98/00500 discloses the use of cellulases, cellulase derivatives or cellulase-like proteins, and WO 01/46357 for this purpose discloses a fusion protein with a binding site for cellulose and a binding site for other compounds.

Interface-active proteins are known in principle. One class of proteins with particularly strong surface activity is that of the so-called “hydrophobins”. Hydrophobins have a marked affinity for interfaces and are therefore suitable for coating surfaces. For example, Teflon can be hydrophilized by coating the Teflon surface with hydrophobins.

Hydrophobins are small proteins of from about 100 to 150 amino acids, which are characteristic of filamentous fungi, for example Schizophyllum commune. They generally have 8 cysteine units.

Hydrophobins can firstly be isolated from natural sources. However, they can also be obtained by means of genetic engineering methods. Our prior application PCT/EP2006/050719 discloses such a preparation process for hydrophobins.

The prior art has proposed the use of hydrophobins for various applications.

WO 96/41882 proposes the use of hydrophobins as emulsifiers, thickeners, surface-active substances, for hydrophilizing hydrophobic surfaces, for improving the water resistance of hydrophilic substrates, for preparing oil-in-water emulsions or water-in-oil emulsions. In addition, pharmaceutical applications such as the production of ointments or creams and cosmetic applications such as skin protection or the production of shampoos or hair rinses are proposed.

EP 1 252 516 discloses the coating of windows, contact lenses, biosensors, medical equipment, vessels for performing tests or for storage, ships' hulls, solid particles or frames or chassis of passenger vehicles with a solution comprising hydrophobins at a temperature of from 30 to 80° C.

WO 03/53383 discloses the use of hydrophobin for treating keratin materials in cosmetic applications.

WO 03/10331 discloses a hydrophobin-coated sensor, for example a test electrode to which further substances, for example electroactive substances, antibodies or enzymes, are bonded in a noncovalent manner.

The use of interface-active non-enzymatic proteins, especially of hydrophobins, as a soil-detaching additive to washing compositions has not been described to date.

It was an object of the invention to provide improved washing compositions and improved processes for washing textiles. It should be notable especially for an improved washing performance in the case of washing at low temperatures.

Accordingly, the use of interface-active non-enzymatic proteins for textile washing has been found.

In a second aspect of the invention, washing compositions which comprise interface-active non-enzymatic proteins have been found.

In a third aspect of the invention, a process for washing in which a wash liquor which comprises interface-active non-enzymatic proteins has been found. In a particular embodiment of the process, the wash is undertaken at a temperature of not more than 60° C.

In a particularly preferred embodiment of the invention, the interface-active non-enzymatic proteins are in each case hydrophobins.

It has been found that, surprisingly, the addition of interface-active non-enzymatic proteins to the wash liquor gives rise to a significant enhancement in the washing action. It was particularly surprising that this effect is found even at low washing temperatures and also even in the case of use of extremely small amounts of proteins. For instance, even at a concentration of only approx. 2.5 ppm of protein in the wash liquor in combination with a convential washing composition at a wash temperature of only 25° C., an enhancement in the washing action of up to 8% is found.

In addition to the enhancement of the soil-detaching action, a graying-inhibiting action is also observed for colored oily stains. Hydrophobic stains which can be detached from the textiles in the course of washing can be deposited back on the laundry in finely divided form and hence lead to graying or discoloration. By its nature, this effect is particularly marked in white or pale-colored fabrics. This problem occurs especially when the surfactants and the builder system are in a low dosage. The inventive addition of interface-active non-enzymatic proteins reduces this redeposition and hence improves the whiteness of the washed fabric compared to fabrics which have been washed without addition of such proteins.

The specific details of the invention are as follows:

To perform the invention, interface-active non-enzymatic proteins are used. The term “non-enzymatic” is intended to mean that the proteins preferably have no or at least no significant enzymatic action.

The term “interface-active” is intended to mean that the protein used has the ability to influence the properties of interfaces. The interfaces in question may be solid-solid, solid-liquid, solid-gaseous, liquid-liquid or liquid-gaseous interfaces. In particular, they may be solid-liquid or liquid-liquid interfaces.

In the case of a solid-liquid interface, the property may, for example, be the hydrophilicity or hydrophobicity of the solid surface, which changes under the influence of the protein used. The change in the hydrophilicity or hydrophobicity can be measured in a known manner by the measurement of the contact angle of a water droplet on the coated and uncoated surface. A further interface property is the change in the surface tension of a liquid, which can be measured by known methods.

To perform the invention, preference is given to using proteins which are interface-active even at low concentrations. Suitable proteins are especially those which have significant interface-active properties even at concentrations of from 0.05 to 50 ppm.

In a preferred embodiment of the invention, the proteins used are those which feature the property of causing an increase in the contact angle of a water droplet (5 μl) of at least 20° after application to a glass surface at room temperature, compared to the contact angle of an equally large water droplet with the uncoated glass surface. Preference is given to using proteins for which the contact angle increase is at least 25°, more preferably at least 300. The performance of contact angle measurements is known in principle to those skilled in the art. The exact experimental conditions for a method suitable by way of example for measuring the contact angle are detailed in the experimental part.

In a particularly preferred embodiment of the invention, the proteins used are hydrophobins.

In the context of the present invention, the term “hydrophobins” should be understood hereinafter to mean polypeptides of the general structural formula (I)

Xₙ—C¹—X₁₋₅₀—C²—X₀₋₅—C³—X₁₋₁₀₀—C⁴—X₁₋₁₀₀—C⁵—X₁₋₅₀—C⁶—X₀₋₅—C^{7-X}₁₋₅₀—C⁸—Xₘ (I)

where X may be any of the 20 naturally occurring amino acids (Phe, Leu, Ser, Tyr, Cys, Trp, Pro, His, Gln, Arg, Ile, Met, Thr, Asn, Lys, Val, Ala, Asp, Glu, Gly). In the formula, the X radicals may be the same or different in each case. The indices beside X are each the number of amino acids in the particular part-sequence X, C is cysteine, alanine, serine, glycine, methionine or threonine, where at least four of the residues designated with C are cysteine, and the indices n and m are each independently natural numbers between 0 and 500, preferably between 15 and 300.

The polypeptides of the formula (I) are also characterized by the property that they bring about an increase in the contact angle of a water droplet of at least 20°, preferably at least 25° and more preferably 30° at room temperature after coating a glass surface, compared in each case with the contact angle of an equally large water droplet with the uncoated glass surface.

The amino acids designated with C¹ to C⁸ are preferably cysteines; however, they may also be replaced by other amino acids with similar space-filling, preferably by alanine, serine, threonine, methionine or glycine. However, at least four, preferably at least 5, more preferably at least 6 and in particular at least 7 of positions C¹ to C⁸ should consist of cysteines. In the inventive proteins, cysteines may either be present in reduced form or form disulfide bridges with one another. Particular preference is given to the intramolecular formation of C—C bridges, especially that with at least one intramolecular disulfide bridge, preferably 2, more preferably 3 and most preferably 4 intramolecular disulfide bridges. In the case of the above-described exchange of cysteines for amino acids with similar space-filling, such C positions are advantageously exchanged in pairs which can form intramolecular disulfide bridges with one another.

If cysteines, serines, alanines, glycines, methionines or threonines are also used in the positions designated with X, the numbering of the individual C positions in the general formulae can change correspondingly.

Preference is given to using hydrophobins of the general formula (II)

Xₙ—C¹—X₃₋₂₅—C²—X₀₋₂—C³—X₅₋₅₀—C⁴—X₂₋₃₅—C⁵—X₂₋₁₅—C⁶—X₀₋₂—C⁷—X₃₋₃₅—C⁸—Xₘ (II)

to perform the present invention, where X, C and the indices beside X and C are each as defined above, the indices n and m are each numbers between 0 and 350, preferably from 15 to 300, the proteins additionally feature the above-illustrated change in contact angle, and, furthermore, at least 6 of the residues designated with C are cysteine. More preferably, all C residues are cysteine.

Particular preference is given to using hydrophobins of the general formula (III)

Xₙ—C¹—X₅₋₉—C²—C³—X₁₁₋₃₉—C⁴—X₂₋₂₃—C⁵—X₅₋₉—C⁶—C⁷—X₆₋₁₈—C⁸—Xₘ (III)

where X, C and the indices beside X are each as defined above, the indices n and m are each numbers between 0 and 200, and the proteins additionally feature the above-illustrated change in contact angle, and at least 6 of the residues designated with C are cysteine. More preferably, all C residues are cysteine.

The Xₙ and Xₘ residues may be peptide sequences which naturally are also joined to a hydrophobin. However, one or both residues may also be peptide sequences which are naturally not joined to a hydrophobin. This is also understood to mean those Xₙ and/or Xₘ residues in which a peptide sequence which occurs naturally in a hydrophobin is lengthened by a peptide sequence which does not occur naturally in a hydrophobin.

If Xₙ and/or Xₘ are peptide sequences which are not naturally bonded to hydrophobins, such sequences are generally at least 20, preferably at least 35, more preferably at least 50 and, for example, at least 100 amino acids in length. The sequences may, for example, be sequences of from 20 to 500, preferably from 30 to 400 and more preferably from 35 to 100 amino acids. Such a residue which is not bonded naturally to a hydrophobin will also be referred to hereinafter as a fusion partner. This is intended to express that the proteins may consist of at least one hydrophobin moiety and a fusion partner moiety which do not occur together in this form in nature.

The fusion partner moiety may be selected from a multitude of proteins. It is also possible for only a single fusion partner to be joined to the hydrophobin moiety, or it is also possible for a plurality of fusion partners to be joined to one hydrophobin moiety, for example on the amino terminus (Xₙ) and on the carboxyl terminus (Xₘ) of the hydrophobin moiety. However, it is also possible, for example, for two fusion partners to be joined to one position (Xₙ or Xₘ) of the inventive protein.

Particularly suitable fusion partners are proteins which naturally occur in microorganisms, especially in E. coli or Bacillus subtilis. Examples of such fusion partners are the sequences yaad (SEQ ID NO: 15 and 16), yaae (SEQ ID NO: 17 and 18), and thioredoxin. Also very suitable are fragments or derivatives of these sequences which comprise only some, for example from 70 to 99%, preferentially from to 50% and more preferably from 10 to 40% of the sequences mentioned, or in which individual amino acids or nucleotides have been changed compared to the sequence mentioned, in which case the percentages are each based on the number of amino acids.

In a further preferred embodiment, the fusion hydrophobin, as well as the fusion partner mentioned, as an Xₙ or Xₘ group or as a terminal constituent of such a group, also has a so-called affinity domain (affinity tag/affinity tail). In a manner known in principle, this comprises anchor groups which can interact with particular complementary groups and can serve for easier workup and purification of the proteins. Examples of such affinity domains comprise (His)ₖ, (Arg)ₖ, (Asp)ₖ, (Phe)ₖ or (Cys)ₖ groups, where k is generally a natural number from 1 to 10. It may preferably be a (His)ₖ group, where k is from 4 to 6. In this case, the Xₙ and/or Xₘ group may consist exclusively of such an affinity domain, or else an Xₙ or Xₘ radical which is naturally bonded or is not naturally bonded to a hydrophobin is extended by a terminal affinity domain.

The proteins used in accordance with the invention as hydrophobins or derivatives thereof may also be modified in their polypeptide sequence, for example by glycosylation, acetylation or else by chemical crosslinking, for example with glutaraldehyde.

One property of the hydrophobins or derivatives thereof used in accordance with the invention is the change in surface properties when the surfaces are coated with the proteins. The change in the surface properties can be determined experimentally, for example, by measuring the contact angle of a water droplet before and after the coating of the surface with the protein and determining the difference of the two measurements.

The performance of contact angle measurements is known in principle to those skilled in the art. The measurements are based on room temperature and water droplets of 5 μl and the use of glass plates as substrates. The exact experimental conditions for an example of a suitable method for measuring the contact angle are given in the experimental section. Under the conditions mentioned there, the fusion proteins used in accordance with the invention have the property of increasing the contact angle by at least 20°, preferably at least 25°, more preferably at least 30°, compared in each case with the contact angle of an equally large water droplet with the uncoated glass surface.

Particularly preferred hydrophobins for performing the present invention are the hydrophobins of the dewA, rodA, hypA, hypB, sc3, basf1, basf2 type, which are characterized structurally in the sequence listing which follows. They may also only be parts or derivatives thereof. It is also possible for a plurality of hydrophobin moieties, preferably 2 or 3, of identical or different structure to be bonded to one another and to be bonded to a corresponding suitable polypeptide sequence which is not bonded to a hydrophobin in nature.

Also particularly suitable in accordance with the invention are the fusion proteins yaad-Xa-dewA-his (SEQ ID NO: 20), yaad-Xa-rodA-his (SEQ ID NO: 22) or yaad-Xa-basf1-his (SEQ ID NO: 24), with the polypeptide sequences specified in brackets and the nucleic acid sequences which code therefor, especially the sequences according to SEQ ID NO: 19, 21, 23; more preferably, it is possible to use yaad-Xa-dewA-his (SEQ ID NO: 20). Proteins which, proceeding from the polypeptide sequences shown in SEQ ID NO. 20, 22 or 24, arise through exchange, insertion or deletion of from at least one up to 10, preferably 5 amino acids, more preferably 5% of all amino acids, and which still have the biological property of the starting proteins to an extent of at least 50%, are also particularly preferred embodiments. A biological property of the proteins is understood here to mean the change in the contact angle by at least 20°, which has already been described.

Derivatives particularly suitable for performing the invention are residues derived from yaad-Xa-dewA-his (SEQ ID NO: 20), yaad-Xa-rodA-his (SEQ ID NO: 22) or yaad-Xa-basf1-his (SEQ ID NO: 24) by truncating the yaad fusion partner. Instead of the complete yaad fusion partner (SEQ ID NO: 16) with 294 amino acids, it may be advantageous to use a truncated yaad residue. The truncated residue should, though, comprise at least 20, more preferably at least 35 amino acids. For example, a truncated radical having from 20 to 293, preferably from 25 to 250, more preferably from 35 to 150 and, for example, from 35 to 100 amino acids may be used. One example of such a protein is yaad40-Xa-dewA-his (SEQ ID NO: 26), which has a yaad residue truncated to 40 amino acids.

A cleavage site between the hydrophobin and the fusion partner or the fusion partners can utilized to release the pure hydrophobin in underivatized form (for example by BrCN cleavage at methionin, factor Xa cleavage, enterokinase cleavage, thrombin cleavage, TEV cleavage, etc.).

It is also possible to generate fusion proteins in succession from one fusion partner, for example yaad or yaae, and a plurality of hydrophobins, even of different sequence, for example DewA-RodA or Sc3-DewA, Sc3-RodA. It is equally possible to use hydrophobin fragments (for example N- or C-terminal truncations) or mutein which have up to 70% homology. The optimal constructs are in each case selected in relation to the particular use, i.e. the liquid phases to be separated.

The hydrophobins used in accordance with the invention used for textile washing can be prepared chemically by known methods of peptide synthesis, for example by Merrifield solid-phase synthesis.

Naturally occurring hydrophobins can be isolated from natural sources by means of suitable methods. Reference is made by way of example to Wösten et. al., Eur. J Cell Bio. 63, 122-129 (1994) or WO 96/41882.

A genetic engineering production method for hydrophobins without fusion partners from Talaromyces thermophilus is described by US 2006/0040349.

Fusion proteins can be prepared preferably by genetic engineering methods, in which one nucleic acid sequence, especially DNA sequence, encoding the fusion partner and one encoding the hydrophobin moiety are combined in such a way that the desired protein is generated in a host organism as a result of gene expression of the combined nucleic acid sequence. Such a preparation process is disclosed, for example, in PCT/EP2006/050719.

Suitable host organisms (production organisms) for the preparation method mentioned may be prokaryotes (including the Archaea) or eukaryotes, particularly bacteria including halobacteria and methanococcia, fungi, insect cells, plant cells and mammalian cells, more preferably Escherichia coli, Bacillus subtilis, Bacillus megaterium, Aspergillus oryzae, Aspergillus nidulans, Aspergillus niger, Pichia pastoris, Pseudomonas spec., lactobacilli, Hansenula polymorpha, Trichoderma reesei, SF9 (or related cells), among others.

The invention also provides for the use of expression constructs comprising, under the genetic control of regulatory nucleic acid sequences, a nucleic acid sequence which encodes a polypeptide used in accordance with the invention, and also vectors comprising at least one of these expression constructs.

Constructs used preferably comprise, 5′ upstream from the particular encoding sequence, a promoter and, 3′ downstream, a terminator sequence and if appropriate further customary regulatory elements, in each case linked operatively to the encoding sequence.

In the context of the present invention, an “operative linkage” is understood to mean the sequential arrangement of promoter, encoding sequence, terminator and if appropriate further regulatory elements such that each of the regulatory elements can fulfil its function as intended in the expression of the encoding sequence.

Examples of operatively linkable sequences are targeting sequences, and also enhancers, polyadenylation signals and the like. Further regulatory elements comprise selectable markers, amplification signals, replication origins and the like. Suitable regulatory sequences are, for example, described in Goeddel, Gene Expression Technology: Methods in Enzymology 185, Academic Press, San Diego, Calif. (1990).

In addition to these regulation sequences, the natural regulation of these sequences may still be present upstream of the actual structural genes and, if appropriate, have been genetically modified so as to switch off the natural regulation and increase the expression of the genes.

A preferred nucleic acid construct also advantageously comprises one or more so-called “enhancer” sequences, joined functionally to the promoter, which enable increased expression of the nucleic acid sequence. Also at the 3′ end of the DNA sequences, it is possible for additional advantageous sequences to be inserted, such as further regulatory elements or terminators.

The nucleic acids may be present in the construct in one or more copies. It is also possible for further markers such as antibiotic resistances or genes which complement auxotrophies to be present in the construct, if appropriate for selection for the construct.

Advantageous regulation sequences for the preparation are present, for example, in promoters such as the cos, tac, trp, tet, trp-tet, lpp, lac, lpp-lac, lacIq-T7, T5, T3, gal, trc, ara, rhaP(rhaPBAD) SP6, lambda-PR or imlambda-P promoter, which advantageously find use in Gram-negative bacteria. Further advantageous regulation sequences are present, for example, in the Gram-positive promoters amy and SP02, and in the yeast or fungal promoters ADC1, MFalpha, AC, P-60, CYC1, GAPDH, TEF, rp28, ADH.

It is also possible to use synthetic promoters for the regulation.

For expression in a host organism, the nucleic acid construct is advantageously inserted into a vector, for example a plasmid or a phage which enables optimal expression of the genes in the host. Apart from plasmids and phages, vectors are also understood to mean all other vectors known to those skilled in the art, for example viruses such as SV40, CMV, baculovirus and adenovirus, transposons, IS elements, phasmids, cosmids, and linear or circular DNA, and also the Agrobacterium system.

These vectors can be replicated autonomously in the host organism or replicated chromosomally. Suitable plasmids are, for example, in E. coli pLG338, pACYC184, pBR322, pUC18, pUC19, pKC30, pRep4, pHS1, pKK223-3, pDHE19.2, pHS2, pPLc236, pMBL24, pLG200, pUR290, pIN-III″3-B1, tgt11 or pBdCl, in Streptomyces pIJ101, pIJ364, pIJ702 or pIJ361, in Bacillus pUB110, pC194 or pBD214, in Corynebacterium pSA77 or pAJ667, in fungi pALS1, pIL2 or pBB116, in yeasts 2alpha, pAG-1, YEp6, YEp13 or pEMBLYe23 or in plants pLGV23, pGHlac+, pBIN19, pAK2004 or pDH51. The plasmids mentioned constitute a small selection of the possible plasmids. Further plasmids are known to those skilled in the art and can be taken, for example, from the book Cloning Vectors (Eds. Pouwels P. H. et al. Elsevier, Amsterdam-New York-Oxford, 1985, ISBN 0 444 904018).

Advantageously, the nucleic acid construct, for the expression of the further genes present, additionally also comprises 3′- and/or 5′-terminal regulatory sequences for enhancing the expression, which are selected for optimal expression depending upon the host organism and gene or genes selected.

These regulatory sequences are intended to enable the controlled expression of the genes and of the protein expression. Depending on the host organism, this can mean, for example, that the gene is expressed or overexpressed only after induction, or that it is expressed and/or overexpressed immediately.

The regulatory sequences or factors can preferably positively influence and thus increase the gene expression of the genes introduced. Thus, an amplification of the regulatory elements can advantageously be effected at the transcription level by using strong transcription signals such as promoters and/or enhancers. In addition, it is also possible to enhance the translation by, for example, improving the stability of the mRNA.

In a further embodiment of the vector, the vector comprising the nucleic acid construct or the nucleic acid can also be introduced into the microorganisms advantageously in the form of a linear DNA and be integrated into the genome of the host organism by means of heterologous or homologous recombination. This linear DNA can consist of a linearized vector such as a plasmid or only of the nucleic acid construct or the nucleic acid.

For an optimal expression of heterologous genes in organisms, it is advantageous to alter the nucleic acid sequences in accordance with the specific “codon usage” used in the organism. The “codon usage” can be determined easily with reference to computer evaluations of other, known genes of the organism in question.

An expression cassette is prepared by fusion of a suitable promoter with a suitable coding nucleotide sequence and a terminator signal or polyadenylation signal. To this end, common recombination and cloning techniques are used, as described, for example, in T. Maniatis, E. F. Fritsch and J. Sambrook, Molecular Cloning: A Laboratory Manual, Cold Spring Harbor Laboratory, Cold Spring Harbor, N.Y. (1989) and in T. J. Silhavy, M. L. Berman and L. W. Enquist, Experiments with Gene Fusions, Cold Spring Harbor Laboratory, Cold Spring Harbor, N.Y. (1984) and in Ausubel, F. M. et al., Current Protocols in Molecular Biology, Greene Publishing Assoc. and Wiley Interscience (1987).

For expression in a suitable host organism, the recombinant nucleic acid construct or gene construct is advantageously inserted into a host-specific vector which enables an optimal expression of the genes in the host. Vectors are well known to those skilled in the art and can be taken, for example, from “Cloning Vectors” (Pouwels P. H. et al., eds., Elsevier, Amsterdam-New York-Oxford, 1985).

With the aid of vectors, it is possible to prepare recombinant microorganisms which have been transformed, for example, with at least one vector and can be used for the production of the hydrophobins or derivatives thereof used in accordance with the invention. Advantageously, the above-described recombinant constructs are introduced into a suitable host system and expressed. Preference is given to using the cloning and transfection methods familiar to those skilled in the art, for example coprecipitation, protoplast fusion, electroporation, retroviral transfection and the like, in order to bring about the expression of the nucleic acids mentioned in the particular expression system. Suitable systems are described, for example, in Current Protocols in Molecular Biology, F. Ausubel et al., ed., Wiley Interscience, New York 1997, or Sambrook et al. Molecular Cloning: A Laboratory Manual, 2nd edition, Cold Spring Harbor Laboratory, Cold Spring Harbor Laboratory Press, Cold Spring Harbor, N.Y., 1989.

It is also possible to prepare homologously recombined microorganisms. To this end, a vector is prepared which comprises at least a section of a gene to be used or a coding sequence, in which, if appropriate, at least one amino acid deletion, addition or substitution has been introduced in order to change, for example to functionally disrupt, the sequence (“knockout” vector). The sequence introduced may, for example, also be a homolog from a related microorganism or be derived from a mammalian, yeast or insect source. The vector used for the homologous recombination may alternatively be configured such that the endogenous gene in the case of homologous recombination has been mutated or altered in another way, but still encodes the functional protein (for example, the upstream regulatory region can be changed such that the expression of the endogenous protein is changed). The changed section of the gene used in accordance with the invention is in the homologous recombination vector. The construction of suitable vectors for homologous recombination is described, for example, in Thomas, K. R. and Capecchi, M. R. (1987) Cell 51: 503.

In principle, all prokaryotic or eukaryotic organisms are useful as recombinant host organisms for such nucleic acids or such nucleic acid constructs. Advantageously, the host organisms used are microorganisms such as bacteria, fungi or yeasts. Advantageously, Gram-positive or Gram-negative bacteria are used, preferably bacteria from the families Enterobacteriaceae, Pseudomonadaceae, Rhizobiaceae, Streptomycetaceae or Nocardiaceae, more preferably bacteria of the genera Escherichia, Pseudomonas, Streptomyces, Nocardia, Burkholderia, Salmonella, Agrobacterium or Rhodococcus.

The organisms used in the preparation process for fusion proteins just described are, depending on the host organism, grown or cultured in a manner known to those skilled in the art. Microorganisms are generally grown in a liquid medium which comprises a carbon source, usually in the form of sugars, a nitrogen source, usually in the form of organic nitrogen sources such as yeast extract or salts such as ammonium sulfate, trace elements such as iron, manganese and magnesium salts, and also, if appropriate, vitamins, at temperatures between 0 and 100° C., preferably between 10 to 60° C., with oxygen sparging. The pH of the nutrient liquid can be kept at a fixed value, i.e. is regulated or not during the growth. The growth can be effected batchwise, semibatchwise or continuously. Nutrients can be introduced at the start of the fermentation or be replenished semicontinuously or continuously. The enzymes can be isolated from the organisms by the process described in the examples or be used for the reaction as a crude extract.

The hydrophobins used in accordance with the invention, or functional, biologically active fragments thereof, can be prepared by means of a process for recombinant preparation, in which a polypeptide-producing microorganism is cultivated, the expression of the proteins is induced if appropriate and they are isolated from the culture. The proteins can also be produced in this way on an industrial scale if this is desired. The recombinant microorganism can be cultivated and fermented by known processes. Bacteria can be propagated, for example, in TB or LB medium and at a temperature of from 20 to 40° C. and a pH of from 6 to 9. Suitable cultivation conditions are described specifically, for example, in T. Maniatis, E. F. Fritsch and J. Sambrook, Molecular Cloning: A Laboratory Manual, Cold Spring Harbor Laboratory, Cold Spring Harbor, N.Y. (1989).

The fusion partners ease the preparation of the hydrophobins considerably. Fusion hydrophobins are produced with significantly better yields than hydrophobins without fusion partners.

If the proteins are not secreted into the culture medium, the cells are then disrupted and the product is obtained from the lysate by known protein isolation processes. As desired, the cells can be disrupted by high-frequency ultrasound, by high pressure, for example in a French pressure cell, by osmolysis, by the action of detergents, lytic enzymes or organic solvents, by homogenizers or by combination of a plurality of the processes listed.

The proteins can be purified by known chromatographic processes, such as molecular sieve chromatography (gel filtration) such as Q Sepharose chromatography, ion exchange chromatography and hydrophobic chromatography, and also with other customary processes such as ultrafiltration, crystallization, salting-out, dialysis and native gel electrophoresis. Suitable processes are described, for example, in Cooper, F. G., Biochemische Arbeitsmethoden [Biochemical Techniques], Verlag Walter de Gruyter, Berlin, New York, or in Scopes, R., Protein Purification, Springer Verlag, New York, Heidelberg, Berlin.

It may be particularly advantageous to ease the isolation and purification of the fusion hydrophobins by providing them with specific anchor groups which can bind to corresponding complementary groups on solid supports, especially suitable polymers. Such solid supports may, for example, be used as a filling for chromatography columns, and the efficiency of the separation can generally be increased significantly in this manner. Such separation processes are also known as affinity chromatography. For the incorporation of the anchor groups, it is possible to use, in the preparation of the proteins, vector systems or oligonucleotides which extend the cDNA by particular nucleotide sequences and hence encode altered proteins or fusion proteins. For easier purification, modified proteins comprise so-called “tags” which function as anchors, for example the modification known as the hexa-histidine anchor. Fusion hydrophobins modified with histidine anchors can be purified chromatographically, for example, using nickel-Sepharose as the column filling. The fusion hydrophobin can subsequently be eluted again from the column by means of suitable agents for elution, for example an imidazole solution.

In a simplified purification process, it is possible to dispense with the chromatographic purification. To this end, the cells are first removed from the fermentation broth by means of a suitable method, for example by microfiltration or by centrifugation. Subsequently, the cells can be disrupted by means of suitable methods, for example by means of the methods already mentioned above, and the cell debris can be separated from the inclusion bodies. The latter can advantageously be effected by centrifugation. Finally, the inclusion bodies can be disrupted in a manner known in principle in order to release the fusion hydrophobins. This can be done, for example, by means of acids, bases, and/or detergents. The inclusion bodies with the fusion hydrophobins used in accordance with the invention can generally be dissolved completely even using 0.1 M NaOH within approx. 1 h. The purity of the fusion hydrophobins obtained by this simplified process is generally from 60 to 80% by weight based on the amount of all proteins.

The solutions obtained by the simplified purification process described can be used to perform this invention without further purification. However, the fusion hydrophobins can also be isolated as a solid from the solutions. This can, for example, be done in a manner known in principle by freeze-drying or spray-drying.

In a preferred embodiment of the invention, the isolation can be effected by means of spray-drying. The spray-drying can be undertaken with the chromatographically purified solution, but it is also possible with preference to use the solutions obtained after the simplified purification process by preparation of the inclusion bodies.

To perform the spray-drying, the solutions may be neutralized if appropriate. A pH range of from 7 to 9 has been found to be particularly advantageous.

It is also generally advisable to concentrate the starting solutions slightly. A useful solid concentration in the starting solution has been found to be up to 30% by weight. A solids content of >5% generally leads to a fine product powder. Subsequently, the solution can be spray-dried in a manner known in principle. Suitable apparatus for spray-drying is commercially available. The optimal spray-drying conditions vary with unit type and desired throughput. Input temperatures of from 130 to 180° C. and output temperatures of from 50 to 80° C. have been found to be favorable for hydrophobin solutions. Optionally, it is possible to use assistants, for example sugars, mannitol, dextran or maltodextrin, for the spray-drying. A useful amount has been found to be from 0 to 30% by weight, preferably from 5 to 20% by weight, of such assistants based on the hydrophobin.

The hydrophobins prepared as described may be used either directly as fusion proteins or, after detachment and removal of the fusion partner, as “pure” hydrophobins.

When a removal of the fusion partner is intended, it is advisable to incorporate a potential cleavage site (specific recognition site for proteases) into the fusion protein between a hydrophobin moiety and fusion partner moiety. Suitable cleavage sites are especially those peptide sequences which otherwise occur neither in the hydrophobin moiety nor in the fusion partner moiety, which can be determined easily with bioinformatic tools. Particularly suitable examples are BrCN cleavage at methionine, or protease-mediated cleavage with factor Xa cleavage, enterokinase cleavage, thrombin cleavage or TEV cleavage (tobacco etch virus protease).

For the inventive use for textile washing, the interface-active non-enzymatic proteins can be used firstly as a component of a washing composition and be added in this form to the wash liquor. However, it is also possible to add the interface-active non-enzymatic protein to the wash liquor separately, and to use a washing composition which is free of interface-active non-enzymatic proteins. The separate addition can be effected by the addition of the protein in solid form, as a solution or as a suitable formulation. It will be appreciated that the two methods of addition can also be combined.

The amount of the interface-active non-enzymatic protein in the wash liquor is determined by the person skilled in the art according to the desired effect. A useful amount has generally been found to be from 0.05 to 50 ppm, preferably from 0.1 to 30 ppm, more preferably from 0.2 to 20 ppm, even more preferably from 0.5 to 10 ppm and, for example, from 1 to 6 ppm.

The inventive washing compositions comprise at least one wash-active substance and at least one interface-active non-enzymatic protein.

The at least one interface-active non-enzymatic protein is preferably a protein which causes the change in the contact angle mentioned at the outset, more preferably at least one hydrophobin. It will be appreciated that it is also possible to use mixtures of different proteins.

If hydrophobins are used, they can be used as a “pure” hydrophobin or else in the form of the abovementioned fusion proteins. Useful examples for performing the present invention have been found to be fusion proteins of the yaad-Xa-dewA-his type (SEQ ID NO: 20), yaad-Xa-rodA-his type (SEQ ID NO: 22) or yaad-Xa-basf1-his type (SEQ ID NO: 24). A particularly useful example has been found to be yaad-Xa-dewA-his (SEQ ID NO: 20) with complete yaad fusion partner or else with a truncated fusion partner, for example yaad40-Xa-dewA-his (SEQ ID NO: 26).

The term “washing composition for textile washing” is self-explanatory and restrictive at the same time. Washing compositions for washing textiles are used, for example, in the form of powders, granules, pellets, pastes, tablets, gels or liquids, generally in aqueous solution (wash liquor). Their action consists of a relatively complex interplay of chemical and physicochemical processes. Washing compositions comprise at least one wash-active substance, but generally a plurality of different wash-active substances which interact to give an optimal wash result. Significant wash-active components of washing compositions are especially surfactants, and also builders, cobuilders, bleach systems and washing composition enzymes. It is additionally possible to use typical additives, for example fragrances, corrosion inhibitors, dye transfer inhibitors, foam inhibitors or optical brighteners as components of washing compositions.

The surfactants may be anionic, nonionic, cationic or amphoteric surfactants.

Suitable nonionic surfactants are in particular:
alkoxylated C₈-C₂₂-alcohols, such as fatty alcohol alkoxylates, oxo alcohol alkoxylates and Guerbet alcohol ethoxylates: the alkoxylation may be effected with ethylene oxide, propylene oxide and/or butylene oxide. Block copolymers or random copolymers may be present. Per mole of alcohol, they typically comprise from 2 to 50 mol, preferably from 3 to 20 mol, of at least one alkylene oxide. A preferred alkylene oxide is ethylene oxide. The alcohols preferably have from 10 to 18 carbon atoms.
alkylphenol alkoxylates, in particular alkylphenol ethoxylates, which comprise C₆-C₁₄-alkyl chains and from 5 to 30 mol of alkylene oxide/mole.
alkyl polyglucosides which comprise C₈-C₂₂-, preferably C₁₀-C₁₈-alkyl chains and generally from 1 to 20, preferably from 1.1 to 5, glucoside units.
N-alkylglucamides, fatty acid amide alkoxylates, fatty acid alkanolamide alkoxylates, and block copolymers of ethylene oxide, propylene oxide and/or butylene oxide.

Suitable anionic surfactants are, for example:
sulfates of (fatty) alcohols having from 8 to 22, preferably from 10 to 18, carbon atoms, in particular C₉-C₁₁-alcohol sulfates, C₁₂-C₁₄-alcohol sulfates, C₁₂-C₁₈-alcohol sulfates, lauryl sulfate, cetyl sulfate, myristyl sulfate, palmityl sulfate, stearyl sulfate and tallow fatty alcohol sulfate.
sulfated alkoxylated C₈-C₂₂-alcohols (alkyl ether sulfates): compounds of this type are prepared, for example, by first alkoxylating a C₈-C₂₂-, preferably a C₁₀-C₁₈-alcohol, for example a fatty alcohol, and then sulfating the alkoxylation product. For the alkoxylation, preference is given to using ethylene oxide.
linear C₈-C₂₀-alkylbenzenesulfonates (LAS), preferably linear C₉-C₁₃-alkylbenzene-sulfonates and C₉-C₁₃-alkyltoluenesulfonates.
alkanesulfonates, in particular C₈-C₂₄-, preferably C₁₀-C₁₈-alkanesulfonates.
soaps, such as the sodium and potassium salts of C₈-C₂₄-carboxylic acids.

The anionic surfactants are added to the washing composition preferably in the form of salts. Suitable salts are, for example, alkali metal salts such as sodium, potassium and lithium salts, and ammonium salts such as hydroxyethylammonium, di(hydroxyethyl)ammonium and tri(hydroxyethyl)ammonium salts.

Suitable cationic surfactants include:
C₇-C₂₅-alkylamines;
N,N-dimethyl-N—(C₂-C₄-hydroxy alkyl)(C₇-C₂₅-alkyl)ammonium salts;
mono- and di(C₇-C₂₅-alkyl)dimethylammonium compounds quaternized with alkylating agents;
ester quats, in particular quaternary esterified mono-, di- and trialkanolamines which have been esterified with C₈-C₂₂-carboxylic acids;
imidazoline quats, in particular 1-alkylimidazolinium salts of the formulae II or III

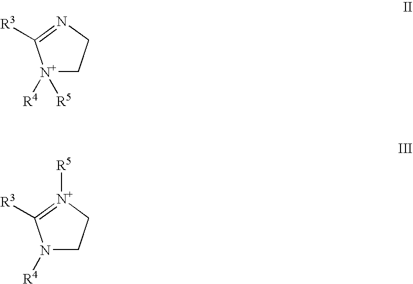

in which the variables are defined as follows:
R³ is C₁-C₂₅-alkyl or C₂-C₂₅-alkenyl;
R⁴ is C₁-C₄-alkyl or hydroxy-C₁-C₄-alkyl;
R⁵ is C₁-C₄-alkyl, hydroxy-C₁-C₄-alkyl or an R¹—(CO)—X—(CH₂)ₘ— radical

### (X: —O— or —NH—; m: 2 or 3),

where at least one R³ radical is C₇-C₂₂-alkyl.

Suitable amphoteric surfactants are, for example, alkyl betaines, alkylamido betaines, aminopropionates, aminoglycinates and amphoteric imidazolium compounds.

In the wash process, builders (also known as heterogeneous inorganic builders, HIBs) serve to soften the water. They support the washing action by their alkalinity and the leaching of calcium and magnesium ions out of soil and fiber bridges, and promote the dispersion of pigmentary soil in the wash liquor.

Suitable inorganic builders are in particular:
crystalline and amorphous alumosilicates having ion-exchanging properties, in particular zeolites: various types of zeolites are suitable, especially the zeolites A, X, B, P, MAP and HS in their Na form or in forms in which Na has been partly exchanged for other cations such as Li, K, Ca, Mg or ammonium.
crystalline silicates, especially disilicates and sheet silicates, for example δ- and β-Na₂Si₂O₅. The silicates may be used in the form of their alkali metal, alkaline earth metal or ammonium salts; preference is given to the sodium, lithium and magnesium silicates.
amorphous silicates, such as sodium metasilicate and amorphous disilicate.
carbonates and hydrogencarbonates: these may be used in the form of their alkali metal, alkaline earth metal or ammonium salts. Preference is given to sodium, lithium and magnesium carbonates and hydrogencarbonates, especially sodium carbonate and/or sodium hydrogencarbonate.
polyphosphates, such as pentasodium triphosphate.

Cobuilders work synergistically with the builders, for example by, as a kind of store, absorbing calcium or magnesium ions more rapidly than the builders and then passing them on to the builders. In addition, they can prevent their growth by adsorption on crystal seeds.

Suitable organic cobuilders are in particular:
low molecular weight carboxylic acids such as citric acid, hydrophobically modified citric acid, e.g. agaric acid, malic acid, tartaric acid, gluconic acid, glutaric acid, succinic acid, imidodisuccinic acid, oxydisuccinic acid, propanetricarboxylic acid, butanetetracarboxylic acid, cyclopentanetetracarboxylic acid, alkyl- and alkenylsuccinic acids and aminopolycarboxylic acids, e.g. nitrilotriacetic acid, β-alaninediacetic acid, ethylenediaminetetraacetic acid, serinediacetic acid, isoserinediacetic acid, N-(2-hydroxyethyl)iminoacetic acid, ethylenediaminedisuccinic acid and methyl- and ethylglycinediacetic acid.
oligomeric and polymeric carboxylic acids such as homopolymers of acrylic acid and aspartic acid, oligomaleic acids, copolymers of maleic acid with acrylic acid, methacrylic acid or C₂-C₂₂-olefins, e.g. isobutene or long-chain α-olefins, vinyl C₁-C₈-alkyl ethers, vinyl acetate, vinyl propionate, (meth)acrylic esters of C₁-C₈-alcohols and styrene. Preference is given to the homopolymers of acrylic acid and copolymers of acrylic acid with maleic acid. The oligomeric and polymeric carboxylic acids are used in acid form or as the sodium salt.

Suitable bleaches are, for example, adducts of hydrogen peroxide to inorganic salts, such as sodium perborate monohydrate, sodium perborate tetrahydrate and sodium carbonate perhydrate, and percarboxylic acids such as phthalimidopercaproic acid.

Suitable bleach activators are, for example, N,N,N′,N′-tetraacetylethylenediamine (TAED), sodium p-nonanoyloxybenzenesulfonate and N-methylmorpholinioacetonitrile methylsulfate.

Enzymes used with preference in washing compositions are proteases, lipases, amylases, cellulases, oxidases and peroxidases.

Suitable dye transfer inhibitors are homopolymers, copolymers and graft polymers of 1-vinylpyrrolidone, 1-vinylimidazole, 4-vinylpyridine N-oxide, or homo- and copolymers of 4-vinylpyridine which have been reacted with chloroacetic acid.

The type and amount of the components used are determined by the person skilled in the art according to the desired end use of the washing composition. For example, bleaches are typically used in heavy-duty washing compositions but not in light-duty washing compositions. Further details on the composition of washing compositions and components of washing compositions can be found, for example, in “Waschmittel” [Washing compositions] in Römpp Chemie-Lexikon, Online edition, Version 2.6, Georg-Thieme-Verlag, Stuttgart, New York, February 2005, or in “Detergents” in Ullmann's Encyclopedia of Industrial Chemistry, 6th Edt., 2000, Electronic Release, Wiley-VCH-Verlag, Weinheim, 2000.

Preferred surfactants for performing the present invention are anionic surfactants and/or nonionic surfactants.

The interface-active non-enzymatic proteins used in accordance with the invention, especially hydrophobins, can be used particularly advantageously with a combination of linear alkylbenzenesulfonates or fatty alcohol sulfates with alkyl ether sulfates or alkyl alkoxylates.

It is particularly advantageously possible to use anionic and/or nonionic surfactants based on C₈-C₁₈-alcohols and/or their alkoxylation products, optionally in a mixture with further surfactants. The alkoxy radicals are preferably those which comprise essentially ethylene oxide units and/or propylene oxide units, preferably ethylene oxide units. They may, for example, be radicals of from 1 to 25 ethylene oxide units, preferably from 3 to 20 and more preferably from 5 to 15 units, or radicals comprising ethylene oxide and propylene oxide units, in which case the latter should comprise in each case at least 50 mol %, preferably 60 mol %, of ethylene oxide units, based on the total number of all alkoxy units.

Examples of preferred surfactants comprise alkoxylated C₈-C₁₈-alcohols, such as fatty alcohol alkoxylates, oxo alcohol alkoxylates, Guerbet alcohol alkoxylates, sulfates of C₈-C₁₈-alcohols, sulfated alkoxylated C₈-C₁₈-alcohols (alkyl ether sulfates) or linear C₈-C₁₈-alkylbenzenesulfonates (LAS), preferably linear C₉-C₁₃-alkylbenzenesulfonates and C₉-C₁₃-alkyltoluenesulfonates.

Particular preference is given to alkoxylation products of 2-propylheptanol and tridecanol and the sulfates thereof.

The amount of the interface-active non-enzymatic proteins in the washing composition is judged by the person skilled in the art according to the desired properties of the washing composition. In this context, the amount is advantageously selected such that, in the case of dosage of the washing composition according to the instructions, the above-specified concentrations of the interface-active non-enzymatic protein are obtained.

A useful amount has been found to be from 0.002 to 2.5% by weight of the interface-active non-enzymatic proteins based on the total amount of all components of the washing composition. The amount is preferably from 0.01 to 1.5% by weight, more preferably from 0.025 to 1.0% by weight, even more preferably from 0.05 to 0.5% by weight and, for example, from 0.1 to 0.3% by weight.

In a preferred embodiment, the inventive washing compositions comprise

from 0.01 to 1.5% by weight of interface-active non-enzymatic proteins,
from 0.5 to 40% by weight of surfactants, preferably anionic and/or nonionic surfactants,
from 59 to 99.45% by weight of further wash-active additives or formulation assistants.

The components (c) used may preferably be lipases and/or amphiphilic polymers, for example ethylene oxide-propylene oxide block copolymers.

The inventive washing compositions can be produced by methods known in principle to those skilled in the art. Details of production processes for washing compositions are given, for example, in the above-cited “Römpp Chemie-Lexikon” or “Ullmann's” references.

The interface-active non-enzymatic proteins may be used to produce the washing composition as a solution or as a solid. Solid proteins may be obtained starting from solutions of the proteins by means of methods known to those skilled in the art, for example spray-drying or freeze-drying.

In the production of the washing composition, it should be ensured that the thermal stress on the interface-active non-enzymatic proteins is not too high. The limit is of course guided by the type of protein. In the case of use of hydrophobins, it has been found to be useful not to exceed a product temperature of 120° C. The process temperature, i.e., for example, the temperature of the gas stream in a spray dryer, may of course also be higher provided that the product temperature does not exceed the critical limit.

Techniques for gentle incorporation of components into washing compositions are known to those skilled in the art. Pulverulent washing compositions can be produced, for example, by, in a first step, producing a crude product from aqueous slurries of the thermally stable components of the washing composition by means of spray-drying, and mixing this crude product in a second step with the thermally sensitive components under gentle conditions. It is generally advisable to introduce the interface-active non-enzymatic proteins used in accordance with the invention in this second step, without any intention that the invention be restricted thereto.

The process according to the invention for washing textile materials comprises at least the steps of:

filling a washing appliance with the textile materials to be washed and an aqueous wash liquor,
applying mechanical energy to the mixture of textile materials and wash liquor,
removing the aqueous wash liquor and optionally rinsing the textile materials, and drying the textile materials.

The washing appliance used may be any type of washing machine. However, the term shall also include vessels which are typically used in handwashing, for example wash tubs or wash basins. In step (a), the washing appliance is first filled with the textiles and an aqueous wash liquor, the sequence being unimportant.

The wash liquor comprises, in a manner known in principle, at least one wash-active substance. According to the invention, the aqueous wash liquor further comprises at least one interface-active non-enzymatic protein. Preferred proteins have already been mentioned. The addition of the interface-active non-enzymatic proteins can be undertaken via the washing composition, or else it can be effected separately. It is preferably effected at the start of the wash cycle, but it can of course also be undertaken at a later time.

The washing operation in process step (b) is promoted in a known manner by the action of mechanical energy on the mixture of textile materials and wash liquor. Mechanical energy can be introduced by washing machines, for example by means of rotating drums, or, in the case of handwashing, by the hands and/or other aids.

The temperature in the course of the washing operation is selected by the person skilled in the art according to the circumstances. For example, the temperature may be 5, 10, 15, 20, 25, 30, 35, 40, 45, 50, 55, 60, 65, 70, 75, 80, 85, 90, 95 or 100° C. The particular advantages of the invention are manifested very particularly in the case of washing at moderate or low temperatures. In a preferred embodiment of the invention, the washing operation is undertaken at a temperature of not more than 60° C., especially at not more than 50° C. A particularly advantageous temperature range for performing the washing process according to the invention is from 5 to 45° C., very particularly preferably from 15 to 35° C. and, for example, from 20 to 30° C.

The concentration of the interface-active non-enzymatic proteins in the course of the washing operation is selected by the person skilled in the art. Preferred concentration ranges have already been mentioned above.

If the addition is effected via the inventive washing compositions, they are used typically in an amount of from 0.05 to 25 g/l, preferably from 0.25 to 15 g/l, more preferably from 0.5 to 10 g/l, even more preferably from 1 to 6 g/l and, for example, from 1.5 to 4 g/l, based in each case on the wash liquor.

After the actual washing operation, the wash liquor is removed in a manner known in principle. In general, the textile materials are subsequently rinsed by one or more rinsing operations and finally dried (process steps (d) and (e)). In the course of rinsing, fabric softeners may be used as an additive.

The process according to the invention is suitable for cleaning all types of textile materials. These may be textile fibers, semifinished and finished textile fabrics and finished garments produced therefrom. These may be customary textiles for clothing, or else domestic textiles, for example carpets, curtains, tablecloths and textile structures which serve technical purposes. These also include unshaped structures, for example fleeces, linear structures such as twine, threads, yarns, lines, strings, laces, knits, cordage, and also three-dimensional structures, for example felts, wovens, nonwovens and waddings. Textile materials may consist of material of natural origin, for example cotton, wool or flax, or of synthetic materials such as polyacrylonitrile, polyamide or polyester. It will be appreciated that they may also be blended fabrics, for example cotton/polyester or cotton/polyamide.

The examples which follow are intended to further illustrate the invention:

### Part A:

Preparation and Test of Hydrophobins Used in Accordance with the Invention

### EXAMPLE 1

### Preparations for the Cloning of yaad-His₆/yaaE-His₆

A polymerase chain reaction was carried out with the aid of the oligonucleotides Hal570 and Hal571 (Hal 572/Hal 573). The template DNA used was genomic DNA of the bacterium Bacillus subtilis. The resulting PCR fragment comprised the coding sequence of the Bacillus subtilis yaaD/yaaE gene, and an NcoI and BglII restriction cleavage site respectively at each end. The PCR fragment was purified and cut with the restriction endonucleases NcoI and BglII. This DNA fragment was used as an insert and cloned into the vector pQE60 from Qiagen, which had been linearized beforehand with the restriction endonucleases NcoI and BglII. The vectors pQE60YAAD#2/pQE60YaaE#5 thus formed may be used to express proteins consisting of YAAD::HIS₆ or YAAE::HIS₆.

| | |
|---|---|
| HaI570: | gcgcgcccatggctcaaacaggtactga |
| HaI571: | gcagatctccagccgcgttcttgcatac |
| HaI572: | ggccatgggattaacaataggtgtactagg |
| HaI573: | gcagatcttacaagtgccttttgcttatattcc |

### EXAMPLE 2

### Cloning of yaad Hydrophobin DewA-His₆

A polymerase chain reaction was carried out with the aid of the oligonucleotides KaM 416 and KaM 417. The template DNA used was genomic DNA of the mold Aspergillus nidulans. The resulting PCR fragment comprised the coding sequence of the hydrophobin gene dewA and an N-terminal factor Xa proteinase cleavage site. The PCR fragment was purified and cut with the restriction endonuclease BamHI. This DNA fragment was used as an insert and cloned into the vector pQE60YAAD#2 which had been linearized beforehand with the restriction endonuclease BglII.

The vector #508 thus formed can be used to express a fusion protein consisting of YAAD::Xa::dewA::HIS₆.

KaM416:
GCAGCCCATCAGGGATCCCTCAGCCTTGGTACCAGCGC
KaM417:
CCCGTAGCTAGTGGATCCATTGAAGGCCGCATGAAGTTCTCCGTCTCCGC

### EXAMPLE 3

### Cloning of yaad Hydrophobin RodA-His₆

The plasmid #513 was cloned analogously to plasmid #508 using the oligonucleotides KaM 434 and KaM 435.

KaM434:
GCTAAGCGGATCCATTGAAGGCCGCATGAAGTTCTCCATTGCTGC
KaM435:
CCAATGGGGATCCGAGGATGGAGCCAAGGG

### EXAMPLE 4

### Cloning of yaad Hydrophobin HypA-His₆

Cloning of HypA in pQE60 (#522)

The oligonucleotides KaM449/KaM450 were used to carry out a PCR. The template DNA used was the plasmid HypA in pCR2.1, produced by Nadicom. The resulting fragment comprised the coding sequence of the hydrophobin HypA gene without start and stop codon. The PCR fragment was purified by means of gel electrophoresis and cut with the restriction endonucleases NcoI and BamHI. This fragment was used as an insert and ligated into the vector pQE60 which had been cut beforehand with NcoI and BglII.

KaM449: GTTACCCCATGGCGATCTCTCGCGTCCTTGTCGCT
KaM450: GCCTGAGGATCCGAGGTTGACATTGACAGGAGAGC

Cloning of HypA in pQE60+YAAD (#523)

The oligonucleotides KaM451/KaM452 were used to carry out a PCR. The template DNA used was the plasmid HypA in pCR2.1, produced by Nadicom. The resulting fragment comprised the coding sequence of the hydrophobin HypA Gene without start and stop codon. The PCR fragment was purified by means of gel electrophoresis and cut with the restriction endonucleases BglII and BamHI. This fragment was used as an insert and ligated into the vector pQE60+YAAD which had been cut beforehand with BglII.

KaM451: CGTAGTAGATCTATGATCTCTCGCGTCCTTGTCGCTGC
KaM452: CGACTAGGATCCGAGGTTGACATTGACAGGAGAGC

### EXAMPLE 5

### Cloning of yaad Hydrophobin HypA-His₆

Cloning of HypB in pQE60 (#524)

The oligonucleotides KaM453/KaM454 were used to carry out a PCR. The template DNA used was the plasmid HypB in puC19, produced by Nadicom. The resulting fragment comprised the coding sequence of the hydrophobin HypB gene without start and stop codon. The PCR fragment was purified by means of gel electrophoresis and cut with the restriction endonucleases NcoI and BamHI. This fragment was used as an insert and ligated into the vector pQE60 which had been cut beforehand with NcoI and BglII.

KaM453: GCTTATCCATGGCGGTCAGCACGTTCATCACTGTCG
KaM454: GCTATAGGATCCCACATTGGCATTAATGGGAGTGC

The oligonucleotides KaM455/KaM456 were used to carry out a PCR. The template DNA used was the plasmid HypB in puC19, produced by Nadicom. The resulting fragment comprised the coding sequence of the hydrophobin HypB gene without start and stop codon. The PCR fragment was purified by means of gel electrophoresis and cut with the restriction endonucleases BglII and BamHI. This fragment was used as an insert and ligated into the vector pQE60+YAAD which had been cut beforehand with BglII.

KaM455: GCTAACAGATCTATGGTCAGCACGTTCATCACTGTC
KaM456: CTATGAGGATCCCACATTGGCATTAATGGGAGTGC

### EXAMPLE 6

### Cloning of yaad Hydrophobin BASF1-His₆

The plasmid #507 was cloned analogously to plasmid #508 using the oligonucleotides KaM 417 and KaM 418.

The template DNA used was a synthetic DNA sequence—hydrophobin BASF1 (see appendix).

KaM417:
CCCGTAGCTAGTGGATCCATTGAAGGCCGCATGAAGTTCTCCGTCTCCGC
KaM418:
CTGCCATTCAGGGGATCCCATATGGAGGAGGGAGACAG

### EXAMPLE 7

### Cloning of yaad Hydrophobin BASF2-His₆

The plasmid #506 was cloned analogously to plasmid #508 using the oligonucleotides KaM 417 and KaM 418.

The template DNA used was a synthetic DNA sequence—hydrophobin BASF2 (see appendix).

KaM417:
CCCGTAGCTAGTGGATCCATTGAAGGCCGCATGAAGTTCTCCGTCTCCGC
KaM418:
CTGCCATTCAGGGGATCCCATATGGAGGAGGGAGACAG

### EXAMPLE 8

### Cloning of yaad Hydrophobin SC3-His₆

The plasmid #526 was cloned analogously to plasmid #508 using the oligonucleotides KaM464 and KaM465.

The template DNA used was cDNA from Schyzophyllum commune (see appendix).

KaM464: CGTTAAGGATCCGAGGATGTTGATGGGGGTGC
KaM465: GCTAACAGATCTATGTTCGCCCGTCTCCCCGTCGT

### EXAMPLE 9

### Fermentation of the Recombinant E. coli Strain yaad Hydrophobin DewA-His₆

Inoculation of 3 ml of LB liquid medium with a yaad hydrophobin DewA-His₆-expressing E. coli strain in 15 ml Greiner tubes. Incubation for 8 h at 37° C. on a shaker at 200 rpm. In each case two 1 l Erlenmeyer flasks with baffles and 250 ml of LB medium (+100 μg/ml of ampicillin) are inoculated with 1 ml in each case of the preliminary culture and incubated for 9 h at 37° C. on a shaker at 180 rpm.

Inoculate 13.5 l of LB medium (+100 μg/ml of ampicillin) with 0.51 of preliminary culture (OD₆₀₀ₙₘ 1:10, measured against H₂O) in a 20 l fermenter. At an OD₆₀ₙₘ of ˜3.5, addition of 140 ml of 100 mM IPTG. After 3 h, cool fermenter to 10° C. and centrifuge off fermentation broth. Use cell pellet for further purification.

### EXAMPLE 10

### Purification of the Recombinant Hydrophobin Fusion Protein

(Purification of Hydrophobin Fusion Proteins which have a C-Terminal His₆ Tag)

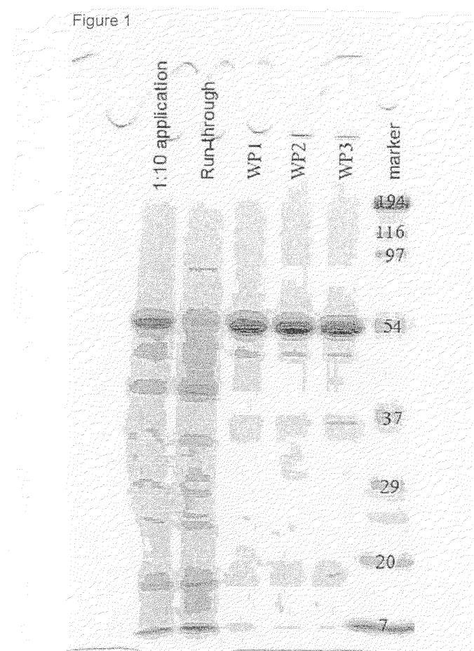

100 g of cell pellet (100-500 mg of hydrophobin) are made up to total volume 200 ml with 50 mM sodium phosphate buffer, pH 7.5, and resuspended. The suspension is treated with an Ultraturrax type T25 (Janke and Kunkel; IKA-Labortechnik) for 10 minutes and subsequently incubated with 500 units of Benzonase (Merck, Darmstadt; order no. 1.01697.0001) at room temperature for 1 hour to degrade the nucleic acids. Before the cell disruption, filtration is effected with a glass cartridge (P1). For cell disruption and for the scission of the remaining genomic DNA, two homogenizer cycles are carried out at 1500 bar (Microfluidizer M-110EH; Microfluidics Corp.). The homogenate is centrifuged (Sorvall RC-5B, GSA rotor, 250 ml centrifuge cup, 60 minutes, 4° C., 12 000 rpm, 23 000 g), the supernatant was placed on ice and the pellet was resuspended in 100 ml of sodium phosphate buffer, pH 7.5. Centrifugation and resuspension are repeated three times, the sodium phosphate buffer comprising 1% SDS at the third repetition. After the resuspension, the mixture is stirred for one hour and a final centrifugation is carried out (Sorvall RC-5B, GSA rotor, 250 ml centrifuge cup, 60 minutes, 4° C., 12 000 rpm, 23 000 g). According to SDS-PAGE analysis, the hydrophobin is present in the supernatant after the final centrifugation (FIG. 1). The experiments show that the hydrophobin is probably present in the form of inclusion bodies in the corresponding E. coli cells. 50 ml of the hydrophobin-comprising supernatant are applied to a 50 ml nickel Sepharose High Performance 17-5268-02 column (Amersham) which has been equilibrated with 50 mM Tris-Cl pH 8.0 buffer. The column is washed with 50 mM Tris-Cl pH 8.0 buffer and the hydrophobin is subsequently eluted with 50 mM Tris-Cl pH 8.0 buffer which comprises 200 mM imidazole. To remove the imidazole, the solution is dialyzed against 50 mM Tris-Cl pH 8.0 buffer.

FIG. 1 shows the purification of the hydrophobin prepared:

Lane 1: Application to nickel-Sepharose column (1:10 dilution)
Lane 2: Flow-through =washing step eluate
Lanes 3-5: OD 280 Maxima of the elution fractions

The hydrophobin of FIG. 1 has a molecular weight of approx. 53 kD. Some of the smaller bands represent degradation products of the hydrophobin.

### EXAMPLE 11

### Performance Testing; Characterization of the Hydrophobin by Change in Contact Angle of a Water Droplet on Glass

### Substrate:

Glass (window glass, Süddeutsche Glas, Mannheim)

The fusion hydrophobin from example 10 was used.

Hydrophobin concentration: 100 μg/ml in aqueous solution; additive: 50 mM sodium acetate pH 4+0.1% polyoxyethylene(20)-sorbitan monolaurate (Tween® 20).
Incubation of glass plates overnight (temperature 80° C.), then wash the coating in distilled water,
then incubation 10 min/80° C./1% sodium dodecylsulfate (SDS) solution in distilled water,
washing in distilled water

The samples are dried under air and the contact angle (in degrees) of a droplet of 5 μl of water is determined at room temperature.

The contact angle was measured on a Dataphysics OCA 15+ contact angle system, Software SCA 20.2.0. (November 2002). The measurement was effected according to the manufacturer's instructions.

Untreated glass gave a contact angle of 30±5°; a coating with the functional hydrophobin according to example 8 (yaad-dewA-his₆) gave contact angles of 75±5°.

### Part B:

### Use of Interface-Active Non-Enzymatic Proteins for Textile Washing

### General Test Description:

To test the action, wash tests were performed in a commercially available test apparatus (Launder-o-meter, from Atlas, USA). Tests were performed in each case with and without addition of the proteins to the wash liquor.

For the tests, commercially available test fabric and test fabric produced in house were used.

| No. | Type | Description | Source |
|---|---|---|---|
| 1 | WFK 10 D | Sebum-pigment soil on cotton | WfK Testgewebe GmbH, Brüggen- |
| | | | Bracht, Germany |
| 2 | WFK 10 PF | Vegetable fat-pigment soil on | WfK Testgewebe GmbH, Brüggen- |
| | | cotton | Bracht, Germany |
| 3 | CFT-CS 32 | Sebum soil on cotton | Center for Testmaterials B.V., |
| | | | Vlaardingen, The Netherlands |
| 4 | EPMA 118 | Sebum-pigment soil on cotton | EMPA Testmaterials, St. Gallen, |
| | | | Switzerland |
| 5 | CFT-CS10 | Dyed butterfat on cotton | Center for Testmaterials, B.V. |
| | | | Vlaardingen, The Netherlands |
| 6 | CFT-CS62 | Dyed porcine tallow on cotton | Center for Testmaterials, B.V. |
| | | | Vlaardingen, The Netherlands |
| 7 | — | Dyed triolein on cotton | in-house production |
| 8 | — | Dyed olive oil on cotton | in-house production |

### Performance of the Wash Tests:

Pieces of 30×30 mm were each cut out of the test fabrics mentioned and sewn onto knitted undyed bleached cotton.

In the case of the commercial test fabric, in each case 2 strips (50 mm×200 mm) were washed under the given conditions together with 5 g of white cotton/polyester blend fabric with in each case 4 (for fabrics 1-4) or in each case 2 (in the case of fabrics 5 and 6) different sewn-on test fabrics.

In the case of the self-produced test fabric, 2 spots in each case of 0.1 g of dyed fat or oil were dripped onto a cotton strip (50 mm×200 mm knitted undyed bleached cotton) and treated at 50° C. for 30 min. Sudan red was used for staining.

After the wash, the fabric was rinsed in 250 ml of tap water for 5 min and then dried.

The washing action was assessed by reflectance measurements at 420 nm before and after the wash.

One test in each case was performed with addition of interface-active non-enzymatic proteins and, under comparative conditions, a test without such an additive but otherwise under exactly identical conditions was performed.

The percentages listed in the results tables report the increase in the washing action in the test with protein addition compared to the test without protein addition, calculated according to the following formula:

Increase in washing action [%]=(I_{E}−I_{0E})/(I_{white}−I_{A})*100

I_{E} here in each case means the reflectance of the test fabric after the test wash, I_{A} the reflectance before performance of the test wash. 0 indicates the comparative test without inventive addition of proteins. I_{white} indicates the reflectance of the clean fabric without staining.

The redeposition of soil was accordingly assessed by comparing the reflectance of the clean white fabric without stains before the wash and after the wash, in each case for the test without addition and with addition of the proteins.

### EXAMPLE 12

### Test Parameters

| | |
|---|---|
| Protein used | Hydrophobin fusion protein yaad-Xa-dew |
| | A-his (SEQ ID NO: 19) |
| Concentration of the protein: | See table 1 |
| Washing composition | Commercially available pulverulent |
| | washing composition |
| | (White Cat, China, 2003) |
| Amount of wash liquor | 250 ml per can |
| Dosage of the washing | 2.0 g/l |
| composition | |
| Liquor ratio | 20:1 |
| Water hardness | 2.5 mmol/l (molar Ca:Mg ratio = 3:1) |
| Wash temperature | 25° C. |
| Wash time | 30 minutes |

The protein was added as a dilute aqueous solution. The test wash was performed and evaluated according to the general description given above. The results are compiled in table 1.

### EXAMPLE 13

### Test Parameters

| | |
|---|---|
| Protein used | Hydrophobin fusion protein yaad-Xa-dew |
| | A-his (SEQ ID NO: 19) |
| Concentration of the protein: | see table 1 |
| Washing composition | Commercially available pulverulent |
| | washing composition (Ariel, China, 2004, |
| | from Procter &Gamble) |
| Amount of wash liquor | 250 ml per can |
| Dosage of the washing | 2.0 g/l |
| composition | |
| Liquor ratio | 20:1 |
| Water hardness | 2.5 mmol/l (molar ratio Ca:Mg = 3:1) |
| Wash temperature | 25° C. |
| Wash time | 30 minutes |

The test wash was performed and evaluated according to the general description given above. The results are compiled in table 1:

TABLE 1
Results of the test wash

| | | | Enhancement of the |
|---|---|---|---|
| | | Protein dosage | washing action |
| Example | Test fabric no. | [mg/l] | [%] |
| 12-1 | 1 | 2.3 | 1.2 |
| 12-2 | 1 | 5.3 | 3.8 |
| 12-3 | 2 | 2.3 | 4.9 |
| 12-4 | 2 | 5.3 | 0.9 |
| 12-5 | 3 | 2.3 | 1.2 |
| 12-6 | 3 | 5.3 | 2.0 |
| 12-7 | 4 | 2.3 | 2.7 |
| 12-8 | 4 | 5.3 | 1.5 |
| 13-1 | 1 | 2.5 | 2.9 |
| 13-2 | 1 | 5.0 | 5.5 |
| 13-3 | 2 | 2.5 | 4.9 |
| 13-4 | 2 | 5.0 | 4.8 |
| 13-5 | 3 | 2.5 | 1.6 |
| 13-6 | 3 | 5.0 | 0.9 |
| 13-7 | 4 | 2.5 | 2.2 |
| 13-8 | 4 | 5.0 | 2.2 |

In all tests, a significant enhancement in the washing action was achieved.

### EXAMPLE 14

For the following test wash, a model formulation for a washing composition composed of an anionic surfactant, a nonionic surfactant and a builder was used in each case.

### Test Parameters:

| | |
|---|---|
| Protein used | Hydrophobin fusion protein |
| | yaad40-Xa-dew A-his (SEQ ID NO: 26) |
| Concentration of the protein: | See table 2 |
| Anionic surfactant | 400 ppm of sodium C_{12/14}--fatty alcohol |
| | sulfate |
| Nonionic cosurfactant | in each case 30 ppm of a C13/15-oxo |
| | alcohol ethoxylate, see table 2 for type of |
| | alkoxylate radical |
| Builder | 250 ppm of sodium carbonate |
| Amount of wash liquor | 250 ml per can |
| Liquor ratio | 20:1 |
| Water hardness | 2.5 mmol/l (molar ratio Ca:Mg = 3:1) |
| Wash temperature | 25° C. |
| Wash time | 30 minutes |

The test wash was performed and evaluated according to the general description given above. The results are summarized in table 2.

TABLE 2
Results of the test wash

| | | | Protein | Enhancement |
|---|---|---|---|---|
| | Test fabric | | dosage | of the washing |
| Example | no. | Cosurfactant | [ppm] | action |
| 14-1 | 5 | C13/15-Oxo alcohol | 5.0 | 0.6% |
| | | ethoxylate | | |
| | | with 7 EO | | |
| 14-2 | 6 | C13/15-Oxo alcohol | 5.0 | 1.1% |
| | | ethoxylate | | |
| | | with 7 EO | | |
| 14-3 | 5 | C13/15-Oxo alcohol | 5.0 | 4.1% |
| | | ethoxylate | | |
| | | with 14 EO/6 PO | | |
| 14-4 | 6 | C13/15-Oxo alcohol | 5.0 | 1.7% |
| | | ethoxylate | | |
| | | with 14 EO/6 PO | | |

EO = ethylene oxide,
PO = propylene oxide

### EXAMPLE 15

For the following wash test, a model formulation for a washing composition composed of an anionic surfactant, a nonionic surfactant and a builder was used in each case.

### Test Parameters:

| | |
|---|---|
| Protein used | Protein A: |
| | Hydrophobin fusion protein |
| | yaad-Xa-dew A-his (SEQ ID NO: 19) |
| | Protein B: |
| | Hydrophobin fusion protein |
| | yaad40-Xa-dew A-his (SEQ ID NO: 26) |
| Concentration of the protein: | See table 3 |
| Anionic surfactant | 400 ppm of sodium |
| | N-dodecylbenzenesulfonate |
| Cosurfactant | in each case 30 ppm, see table 3 for type |
| Builder | 250 ppm of sodium carbonate |
| Amount of wash liquor | 250 ml per can |
| Liquor ratio | 20:1 |
| Water hardness | 2.5 mmol/l (molar ratio Ca:Mg = 3:1) |
| Wash temperature | 25° C. |
| Wash time | 30 minutes |

The test wash was performed and evaluated according to the general description given above. The results are summarized in table 3.

TABLE 3
Results of the test wash

| | | | | | Enhancement | |
|---|---|---|---|---|---|---|
| | | | | | of | |
| | Test | | Protein | | the | Reduction |
| | fabric | | | Amount | washing | of re- |
| Example | no. | Cosurfactant | Type | [ppm] | action | deposition |
| 15-1 | 7 | C13/15-Oxo alcohol | A | 5 | 1.5% | 15% |
| | | ethoxylate with 7 EO | | | | |
| 15-2 | 7 | Alkyl ether sulfate: C13/15- | B | 5 | 2.1% | 54% |
| | | Oxo alcohol ethoxylate with 7 | | | | |
| | | EO, sulfated, sodium salt | | | | |
| 15-3 | 8 | C13/15-Oxo alcohol | A | 5 | 0.9% | 0% |
| | | ethoxylate with 7 EO | | | | |
| 15-4 | 8 | Alkyl ether sulfate: C13/15- | B | 5 | 3.6% | 40% |
| | | Oxo alcohol ethoxylate with 7 | | | | |
| | | EO, sulfated, sodium salt | | | | |

EO = ethylene oxide,
PO = propylene oxide

In all tests, an enhancement in the washing action was achieved in each case. The fusion hydrophobin with a truncated yaad fusion partner (B) (40 amino acids) achieved better results in each case than the fusion hydrophobin (A) with a complete yaad fusion partner (294 amino acids).

### Assignment of the Sequence Names to DNA and Polypeptide Sequences in the Sequence Listing

| | |
|---|---|
| dewA DNA and polypeptide sequence | SEQ ID NO: 1 |
| dewA polypeptide sequence | SEQ ID NO: 2 |
| rodA DNA and polypeptide sequence | SEQ ID NO: 3 |
| rodA polypeptide sequence | SEQ ID NO: 4 |
| hypA DNA and polypeptide sequence | SEQ ID NO: 5 |
| hypA polypeptide sequence | SEQ ID NO: 6 |
| hypB DNA and polypeptide sequence | SEQ ID NO: 7 |
| hypB polypeptide sequence | SEQ ID NO: 8 |
| sc3 DNA and polypeptide sequence | SEQ ID NO: 9 |
| sc3 polypeptide sequence | SEQ ID NO: 10 |
| basf1 DNA and polypeptide sequence | SEQ ID NO: 11 |
| basf1 Polypeptide sequence | SEQ ID NO: 12 |
| basf2 DNA and polypeptide sequence | SEQ ID NO: 13 |
| basf2 Polypeptide sequence | SEQ ID NO: 14 |
| yaad DNA and polypeptide sequence | SEQ ID NO: 15 |
| yaad polypeptide sequence | SEQ ID NO: 16 |
| yaae DNA and polypeptide sequence | SEQ ID NO: 17 |
| yaae polypeptide sequence | SEQ ID NO: 18 |
| yaad-Xa-dewA-his DNA and polypeptide sequence | SEQ ID NO: 19 |
| yaad-Xa-dewA-his polypeptide sequence | SEQ ID NO: 20 |
| yaad-Xa-rodA-his DNA and polypeptide sequence | SEQ ID NO: 21 |
| yaad-Xa-rodA-his polypeptide sequence | SEQ ID NO: 22 |
| yaad-Xa-basf1-his DNA and polypeptide sequence | SEQ ID NO: 23 |
| yaad-Xa-basf1-his polypeptide sequence | SEQ ID NO: 24 |
| yaad40-Xa-dewA-his DNA and polypeptide sequence | SEQ ID NO: 25 |
| yaad40-Xa-dewA-his polypeptide sequence | SEQ ID NO: 26 |

1-23. (canceled)

24. A washing composition for textile washing comprising at least one wash-active substance, wherein the washing composition further comprises at least one interface-active non-enzymatic protein, which is characterized by the property of bringing about an increase in the contact angle of a water droplet of at least 20° after application to a glass surface at room temperature, compared to the contact angle of an equally large water droplet with the uncoated glass surface, and wherein the protein is a hydrophobin.

25. The washing composition of claim 24, wherein the protein is a fusion hydrophobin comprising a hydrophobin and a fusion partner, wherein the fusion partner comprising from 20 to 500 amino acids.

26. The washing composition of claim 25, wherein the hydrophobin is at least one selected from the group of yaad-Xa-dewA-his (SEQ ID NO: 20), yaad-Xa-rodA-his (SEQ ID NO: 22) or yaad-Xa-basf1-his (SEQ ID NO: 24), with the proviso that yaad may in each case also be a truncated yaad fusion partner having from 20 to 293 amino acids.

27. The washing composition of claim 24, wherein the amount of the hydrophobins is from 0.002 to 2.5% by weight based on all components of the washing composition.

28. The washing composition of claim 27, which comprises
(a) from 0.01 to 1.5% by weight of hydrophobins,
(b) from 0.5 to 40% by weight of surfactant, and
(c) from 59 to 99.45% by weight of further wash-active additives or formulation assistants.

29. The washing composition of claim 28, wherein the surfactants are anionic and/or nonionic surfactants.

30. The washing composition of claim 29, wherein the surfactants are a combination of linear alkylbenzenesulfonates or fatty alcohol sulfates with alkyl ether sulfates or alkyl alkoxylates.

31. A process for washing textile materials comprising at least the following steps:
(a) filling a washing appliance with the textile materials to be washed and an aqueous wash liquor,
(b) applying mechanical energy to the mixture of textile materials and wash liquor,
(c) removing the aqueous wash liquor and optionally rinsing the textile materials, and
(d) drying the textile materials,
wherein the aqueous wash liquor comprises at least one interface-active non-enzymatic protein, which is characterized by the property of bringing about an increase in the contact angle of a water droplet of at least 20° after application to a glass surface at room temperature, compared to the contact angle of an equally large water droplet with the uncoated glass surface, and wherein the protein is a hydrophobin.

32. The process of claim 31, wherein the protein is a fusion hydrophobin comprising a hydrophobin and a fusion partner, wherein the fusion partner comprising from 20 to 500 amino acids.

33. The process of claim 32, wherein the hydrophobin is at least one selected from the group of yaad-Xa-dewA-his (SEQ ID NO: 20), yaad-Xa-rodA-his (SEQ ID NO: 22) or yaad-Xa-basf1-his (SEQ ID NO: 24), with the proviso that yaad may in each case also be a truncated yaad fusion partner having from 20 to 293 amino acids.

34. The process of claim 31, wherein the proteins are used in combination with anionic and/or nonionic surfactants, which comprises a combination of linear alkylbenzenesulfonates or fatty alcohol sulfates with alkyl ether sulfates or alkyl alkoxylates.

35. The process of claim 31, wherein the washing operation is undertaken at a temperature of not more than 60° C.

36. The process of claim 31, wherein the washing operation is undertaken at a temperature of from 5 to 45° C.

37. The process of claim 31, wherein the washing operation is undertaken at a temperature of from 15 to 35° C.

38. The process of claim 31, wherein the protein is used in a concentration of from 0.05 to 50 ppm in the wash liquor.


SEQUENCE LISTING (45 sequences)

SEQ ID NO: 1 - DNA, 405 bp, Aspergillus nidulans
  CDS (1)..(405)
atgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgag

SEQ ID NO: 2 - protein, 135 aa, Aspergillus nidulans
MRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAE

SEQ ID NO: 3 - DNA, 471 bp, Aspergillus nidulans
  CDS (1)..(471)
atgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctc

SEQ ID NO: 4 - protein, 157 aa, Aspergillus nidulans
MKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSIL

SEQ ID NO: 5 - DNA, 336 bp, Agaricus bisporus
  CDS (1)..(336)
atgatctctcgcgtccttgtcgctgctctcgtcgctctccccgctcttgttactgcaactcctgctcccggaaagcctaaagccagcagtcagtgcgacgtcggtgaaatccattgctgtgacactcagcagactcccgaccacaccagcgccgccgcgtctggtttgcttggtgttcccatcaaccttggtgctttcctcggtttcgactgtacccccatttccgtccttggcgtcggtggcaacaactgtgctgctcagcctgtctgctgcacaggaaatcaattcaccgcattgattaacgctcttgactgctctcctgtcaatgtcaacctc

SEQ ID NO: 6 - protein, 112 aa, Agaricus bisporus
MISRVLVAALVALPALVTATPAPGKPKASSQCDVGEIHCCDTQQTPDHTSAAASGLLGVPINLGAFLGFDCTPISVLGVGGNNCAAQPVCCTGNQFTALINALDCSPVNVNL

SEQ ID NO: 7 - DNA, 357 bp, Agaricus bisporus
  CDS (1)..(357)
atggtcagcacgttcatcactgtcgcaaagacccttctcgtcgcgctcctcttcgtcaatatcaatatcgtcgttggtactgcaactaccggcaagcattgtagcaccggtcctatcgagtgctgcaagcaggtcatggattctaagagccctcaggctacggagcttcttacgaagaatggccttggcctgggtgtccttgctggcgtgaagggtcttgttggcgcgaattgcagccctatcacggcaattggtattggctccggcagccaatgctctggccagaccgtttgctgccagaataataatttcaacggtgttgtcgctattggttgcactcccattaatgccaatgtg

SEQ ID NO: 8 - protein, 119 aa, Agaricus bisporus
MVSTFITVAKTLLVALLFVNINIVVGTATTGKHCSTGPIECCKQVMDSKSPQATELLTKNGLGLGVLAGVKGLVGANCSPITAIGIGSGSQCSGQTVCCQNNNFNGVVAIGCTPINANV

SEQ ID NO: 9 - DNA, 408 bp, Schizophyllum communae
  CDS (1)..(408)
atgttcgcccgtctccccgtcgtgttcctctacgccttcgtcgcgttcggcgccctcgtcgctgccctcccaggtggccacccgggcacgaccacgccgccggttacgacgacggtgacggtgaccacgccgccctcgacgacgaccatcgccgccggtggcacgtgtactacggggtcgctctcttgctgcaaccaggttcaatcggcgagcagcagccctgttaccgccctcctcggcctgctcggcattgtcctcagcgacctcaacgttctcgttggcatcagctgctctcccctcactgtcatcggtgtcggaggcagcggctgttcggcgcagaccgtctgctgcgaaaacacccaattcaacgggctgatcaacatcggttgcacccccatcaacatcctc

SEQ ID NO: 10 - protein, 136 aa, Schizophyllum communae
MFARLPVVFLYAFVAFGALVAALPGGHPGTTTPPVTTTVTVTTPPSTTTIAAGGTCTTGSLSCCNQVQSASSSPVTALLGLLGIVLSDLNVLVGISCSPLTVIGVGGSGCSAQTVCCENTQFNGLINIGCTPINIL

SEQ ID NO: 11 - DNA, 483 bp, Artificial sequence
  CDS (1)..(483): Artificial hydrophobin sequence with characteristic cysteine-pattern
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatg

SEQ ID NO: 12 - protein, 161 aa, Artificial sequence
  Artificial hydrophobin sequence with characteristic cysteine-pattern
MKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHM

SEQ ID NO: 13 - DNA, 465 bp, Artificial sequence
  CDS (1)..(465): Artificial hydrophobin sequence with characteristic cysteine-pattern
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccagcagtgcaagcagaacatcgcctgctgccagaactccccttccgacgccaccggctccctcgtcaacctcggcaacccttgcatccctgtctccctcctccatatg

SEQ ID NO: 14 - protein, 155 aa, Artificial sequence
  Artificial hydrophobin sequence with characteristic cysteine-pattern
MKFSVSAAVLAFAASVAALPQHDSAAGNGNGVGNKFPVPDDVTVKQATDKCGDQAQLSCCNKATYAGDVTDIDEGILAGLLKNLIGGGSGSEGLGLFDQCVKLDLQISVIGIPIQDLLNQQCKQNIACCQNSPSDATGSLVNLGNPCIPVSLLHM

SEQ ID NO: 15 - DNA, 882 bp, Bacillus subtilis
  CDS (1)..(882)
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctgg

SEQ ID NO: 16 - protein, 294 aa, Bacillus subtilis
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGW

SEQ ID NO: 17 - DNA, 591 bp, Bacillus subtilis
  CDS (1)..(591)
atgggattaacaataggtgtactaggacttcaaggagcagttagagagcacatccatgcgattgaagcatgcggcgcggctggtcttgtcgtaaaacgtccggagcagctgaacgaagttgacgggttgattttgccgggcggtgagagcacgacgatgcgccgtttgatcgatacgtatcaattcatggagccgcttcgtgaattcgctgctcagggcaaaccgatgtttggaacatgtgccggattaattatattagcaaaagaaattgccggttcagataatcctcatttaggtcttctgaatgtggttgtagaacgtaattcatttggccggcaggttgacagctttgaagctgatttaacaattaaaggcttggacgagccttttactggggtattcatccgtgctccgcatattttagaagctggtgaaaatgttgaagttctatcggagcataatggtcgtattgtagccgcgaaacaggggcaattccttggctgctcattccatccggagctgacagaagatcaccgagtgacgcagctgtttgttgaaatggttgaggaatataagcaaaaggcacttgta

SEQ ID NO: 18 - protein, 197 aa, Bacillus subtilis
MGLTIGVLGLQGAVREHIHAIEACGAAGLVVKRPEQLNEVDGLILPGGESTTMRRLIDTYQFMEPLREFAAQGKPMFGTCAGLIILAKEIAGSDNPHLGLLNVVVERNSFGRQVDSFEADLTIKGLDEPFTGVFIRAPHILEAGENVEVLSEHNGRIVAAKQGQFLGCSFHPELTEDHRVTQLFVEMVEEYKQKALV

SEQ ID NO: 19 - DNA, 1329 bp, Artificial sequence
  CDS (1)..(1329): DNA sequence encoding fusion protein yaad-Xa-dewA-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatccattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 20 - protein, 443 aa, Artificial sequence
  fusion protein yaad-Xa-dewA-his
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

SEQ ID NO: 21 - DNA, 1395 bp, Artificial sequence
  CDS (1)..(1395): DNA sequence encoding fusion protein yaad-Xa-rodA-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctcggatctcatcaccatcaccatcac

SEQ ID NO: 22 - protein, 465 aa, Artificial sequence
  fusion protein yaad-Xa-rodA-his
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSILGSHHHHHH

SEQ ID NO: 23 - DNA, 1407 bp, Artificial sequence
  CDS (1)..(1407): DNA sequence encoding fusion protein yaad-Xa-basf1-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatgggatctcatcaccatcaccatcac

SEQ ID NO: 24 - protein, 469 aa, Artificial sequence
  fusion protein yaad-Xa-basf1-his
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHMGSHHHHHH

SEQ ID NO: 25 - DNA, 561 bp, Artificial sequence
  CDS (1)..(561): DNA sequence encoding fusion protein yaad40-Xa-dewA-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 26 - protein, 187 aa, artificial sequence
  fusion protein yaad40-Xa-dewA-his
MAQTGTERVKRGMAEMQKGGVIMDVINAEQAKIAEEAGAVIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

SEQ ID NO: 27 - DNA, 28 bp, Artificial sequence
  Oligonucleotide
gcgcgcccatggctcaaacaggtactga

SEQ ID NO: 28 - DNA, 28 bp, Artificial sequence
  Oligonucleotide
gcagatctccagccgcgttcttgcatac

SEQ ID NO: 29 - DNA, 30 bp, Artificial sequence
  Oligonucleotide
ggccatgggattaacaataggtgtactagg

SEQ ID NO: 30 - DNA, 33 bp, Artificial sequence
  Oligonucleotide
gcagatcttacaagtgccttttgcttatattcc

SEQ ID NO: 31 - DNA, 38 bp, Artificial sequence
  Oligonucleotide
gcagcccatcagggatccctcagccttggtaccagcgc

SEQ ID NO: 32 - DNA, 50 bp, Artificial sequence
  Oligonucleotide
cccgtagctagtggatccattgaaggccgcatgaagttctccgtctccgc

SEQ ID NO: 33 - DNA, 45 bp, Artificial sequence
  Oligonucleotide
gctaagcggatccattgaaggccgcatgaagttctccattgctgc

SEQ ID NO: 34 - DNA, 30 bp, Artificial sequence
  Oligonucleotide
ccaatggggatccgaggatggagccaaggg

SEQ ID NO: 35 - DNA, 35 bp, Artificial sequence
  Oligonucleotide
gttaccccatggcgatctctcgcgtccttgtcgct

SEQ ID NO: 36 - DNA, 35 bp, Artificial sequence
  Oligonucleotide
gcctgaggatccgaggttgacattgacaggagagc

SEQ ID NO: 37 - DNA, 38 bp, Artificial sequence
  Oligonucleotide
cgtagtagatctatgatctctcgcgtccttgtcgctgc

SEQ ID NO: 38 - DNA, 35 bp, Artificial sequence
  Oligonucleotide
cgactaggatccgaggttgacattgacaggagagc

SEQ ID NO: 39 - DNA, 36 bp, Artificial sequence
  Oligonucleotide
gcttatccatggcggtcagcacgttcatcactgtcg

SEQ ID NO: 40 - DNA, 35 bp, Artificial sequence
  Oligonucleotide
gctataggatcccacattggcattaatgggagtgc

SEQ ID NO: 41 - DNA, 36 bp, Artificial sequence
  Oligonucleotide
gctaacagatctatggtcagcacgttcatcactgtc

SEQ ID NO: 42 - DNA, 35 bp, Artificial sequence
  Oligonucleotide
ctatgaggatcccacattggcattaatgggagtgc

SEQ ID NO: 43 - DNA, 38 bp, Artificial sequence
  Oligonucleotide
ctgccattcaggggatcccatatggaggagggagacag

SEQ ID NO: 44 - DNA, 32 bp, Artificial sequence
  Oligonucleotide
cgttaaggatccgaggatgttgatgggggtgc

SEQ ID NO: 45 - DNA, 35 bp, Artificial sequence
  Oligonucleotide
gctaacagatctatgttcgcccgtctccccgtcgt